(19) United States
(12) Patent Application Publication
(10) Pub. No.: US 2008/0024262 A1
(43) Pub. Date: Jan. 31, 2008

(54) Transformer with insulating structure

(75) Inventors: Yuan-Ming Chang, Taoyuan Hsien (TW); Chen-Feng Wu, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/822,260

(22) Filed: Jul. 3, 2007

(30) Foreign Application Priority Data
Jul. 28, 2006 (TW) 095127663

(51) Int. Cl. H01F 27/30

(52) U.S. Cl. 336/208; 336/198

(57) ABSTRACT

A transformer with insulating structure includes a bobbin, a first winding, a second winding, a core set and a cover. The bobbin has a non-winding area with a plurality of partitions, and an insulating slot is formed between adjacent two partitions. The first winding and the second winding are wound around the bobbin, and the non-winding area is located between the first winding and the second winding. The core set is disposed around the first winding and the second winding. The cover includes a plurality of insulating protrusions extending into the insulating slots so that the insulating protrusions and partitions are alternately arranged to form a closed path and attain the insulation effect.

### CROSS REFERENCE TO RELATED APPLICATIONS

This Non-provisional application claims priority under 35 U.S.C. §119(a) on Patent Application No(s). 095127663 filed in Taiwan, Republic of China on Jul. 28, 2006, the entire contents of which are hereby incorporated by reference.

### BACKGROUND OF THE INVENTION

1. Field of Invention

The invention relates to a transformer and in particular, to a transformer with an insulating structure.

2. Related Art

As shown in FIGS. 1 and 2, a conventional transformer 1 includes a bobbin 11, two cores 12 and a cover 13. The bobbin 11 has a primary winding area 111, a secondary winding area 112 and a through hole 113. A primary winding 141 is wound around the primary winding area 111, and a secondary winding 142 is wound around the secondary winding area 112. The cover 13 covers on one side of the bobbin 11, and the cores 12 oppositely pass the through hole 113 of the bobbin 11 so as to assemble the transformer 1. The transformer 1 can be insulated only by the cover 13. However, the primary winding 141 and the secondary winding 142 are very close, so the cover 13 is unable to prevent the arcing between the primary winding 141 and the secondary winding 142. Therefore, when the conventional transformer 1 is applied with high voltage, the distance between the primary winding 141 and the secondary winding 142 may not fit the clearance and creepage distances of the safety regulations in insulation.

Therefore, it is an important subject to provide a transformer with an insulating structure that can fit the safety regulations in insulation.

### SUMMARY OF THE INVENTION

In view of the foregoing, the invention is to provide a transformer having an insulating structure for fitting the safety regulations in insulation.

To achieve the above, the invention discloses a transformer including a bobbin, a first winding, a second winding, a core set and a cover. The bobbin has a first winding area, a second winding area and a non-winding area disposed between the first winding area and the second winding area. The non-winding area has a plurality of partitions, and an insulating slot is formed between adjacent two partitions. The first winding is wound around the first winding area of the bobbin, and the second winding is wound around the second winding area of the bobbin. The core set has two cores with the centers thereof abut against each other in a through hole of the bobbin to dispose around the first winding and the second winding. The cover covers the bobbin, the first winding and the second winding. A plurality of insulating protrusions are disposed on the inner wall of the cover, and the insulating protrusions are correspondingly disposed in the insulating slots.

As mentioned above, after the assembling of the transformer of the invention, the insulating protrusions of the cover and the insulating slots of the bobbin are correspondingly disposed, so that the insulating protrusions and the insulating partitions are alternately arranged. Therefore, an insulating structure is formed between the primary and secondary windings, and the bobbin, first winding and second winding can be covered in a closed path formed by the cover so as to attain the insulation effect. Compared with the prior art, the transformer of the invention has the insulating structure capable of insulating the primary and secondary windings efficiently. Thus, the transformer of the invention can fit the clearance and creepage distances requirements in the safety regulations.

In more details, the cover includes a first casing and a second casing, which can be combined to cover the bobbin, first winding and second winding. A plurality of first insulating protrusions are disposed on the inner wall of the first casing and positioned corresponding to the insulating slots. A plurality of second insulating protrusions are disposed on the inner wall of the second casing and positioned corresponding to the insulating slots. Preferably, the first insulating protrusions and the second insulating protrusions are correspondingly connected to form the closed path.

### BRIEF DESCRIPTION OF THE DRAWINGS

The invention will become more fully understood from the detailed description given herein below illustration only, and thus is not limitative of the present invention, and wherein:

FIG. 1 is an exploded diagram of the conventional transformer;

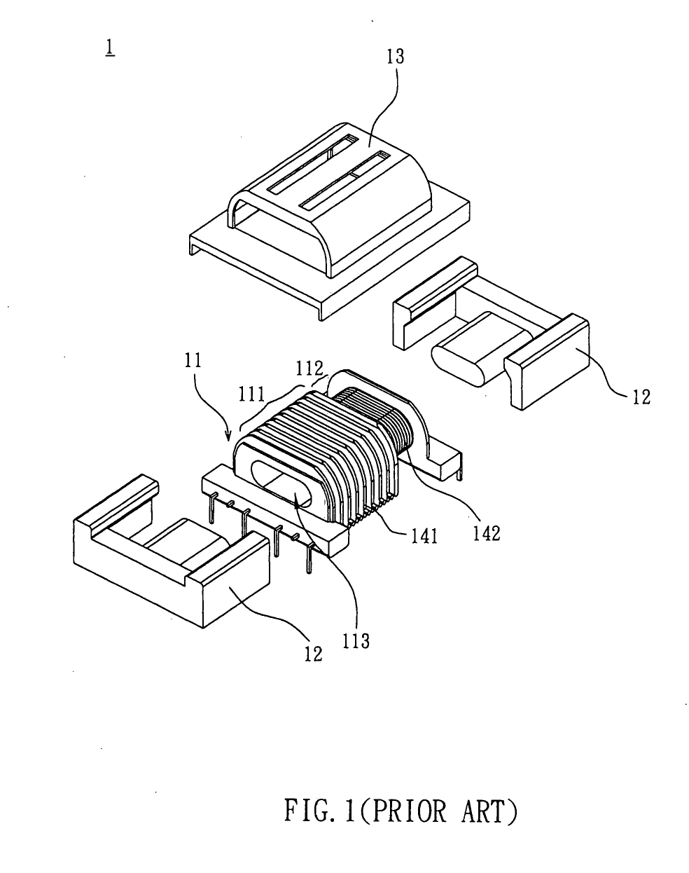

FIG. 2 is a schematic view showing the assembled conventional transformer;

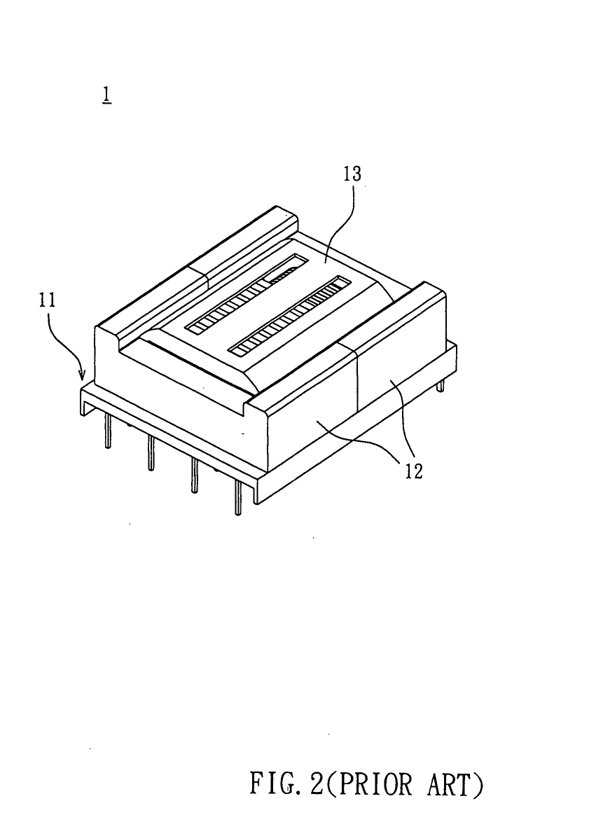

FIG. 3 is an exploded diagram of a transformer according to an embodiment of the invention;

FIG. 4 is a schematic view showing the assembled transformer of FIG. 3; and

FIG. 5 is a cross-sectional view of the transformer along line AA′ shown in FIG. 4.

### DETAILED DESCRIPTION OF THE INVENTION

The present invention will be apparent from the following detailed description, which proceeds with reference to the accompanying drawings, wherein the same references relate to the same elements.

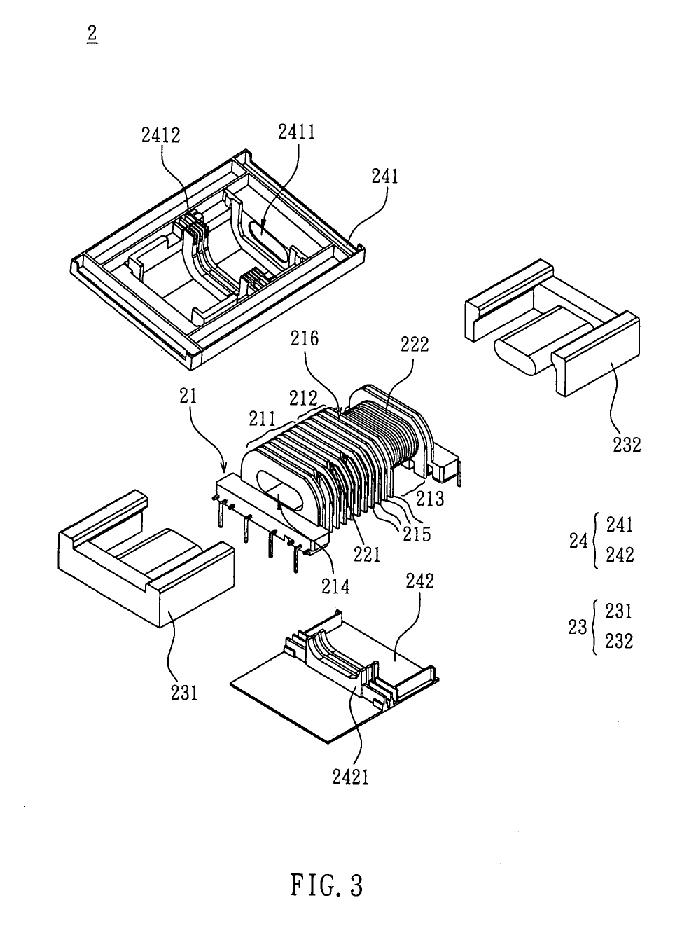

With reference to FIG. 3, a transformer 2 according to an embodiment of the invention includes a bobbin 21, a first winding 221, a second winding 222, a core set 23 and a cover 24. The bobbin 21 has a first winding area 211, a non-winding area 212 and a second winding area 213. The first winding 221 is wound around the first winding area 211. In the embodiment, the first winding 221 is a primary winding and is used as a voltage input terminal. The second winding 222 is wound around the second winding area 213. In the embodiment, the second winding 221 is a secondary winding and is used as a voltage output terminal. Alternatively, the first winding 221 can be a secondary winding while the second winding 222 can be a primary winding. The non-winding area 212 is disposed between the first winding area 211 and the second winding area 213. The non-winding area 212 has a plurality of partitions 215, which are a part of the insulating structure for the first winding 221 and the second winding 222. An insulating slot 216 is formed between adjacent two partitions 215. In the embodiment, the first winding 221 and the second winding 22 can be formed by winding a single wire or they can be formed by winding separate wires.

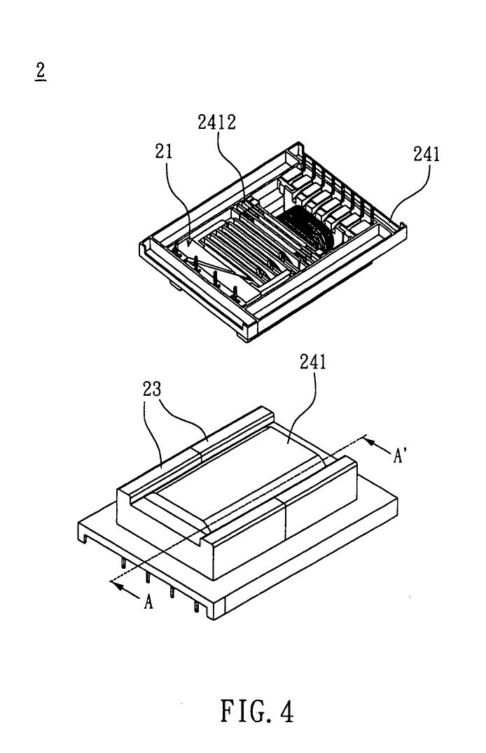

Referring to FIGS. 3 and 4, the cover 24 of the transformer 2 is made of a non-magnetic material such as, but not limited to, plastic. In the embodiment, the cover 24 includes a first casing 241 and a second casing 242, which can combine to cover the bobbin 21, first winding 221 and second winding 222. The first casing 241 is an upper housing of the transformer 2, and the second casing 242 is a lower housing of the transformer 2. A plurality of first insulating protrusions 2412 are disposed on the inner wall of the first casing 241 and positioned corresponding to the insulating slots 216 between the partitions 215. Similarly, a plurality of second insulating protrusions 2421 are disposed on the inner wall of the second casing 242 and positioned corresponding to the insulating slots 216 between the partitions 215. In the embodiment, the shapes of the first insulating protrusions 2412 and second insulating protrusions 2421 are fitted with the bobbin 21. In particular, the shapes of the first insulating protrusions 2412 and second insulating protrusions 2421 are fitted with the shapes of the insulating slots 216.

The core set 23 has two cores 231 and 232. In the embodiment, the core set 23 is an EE-type core set. Of course, the core set 23 is not limited and can be an EF-type core set, an EI-type core set, an EC-type core set, an EER-type core set, an ETD-type core set, an UI-type core set, an EPC-type core set or an EFD-type core set.

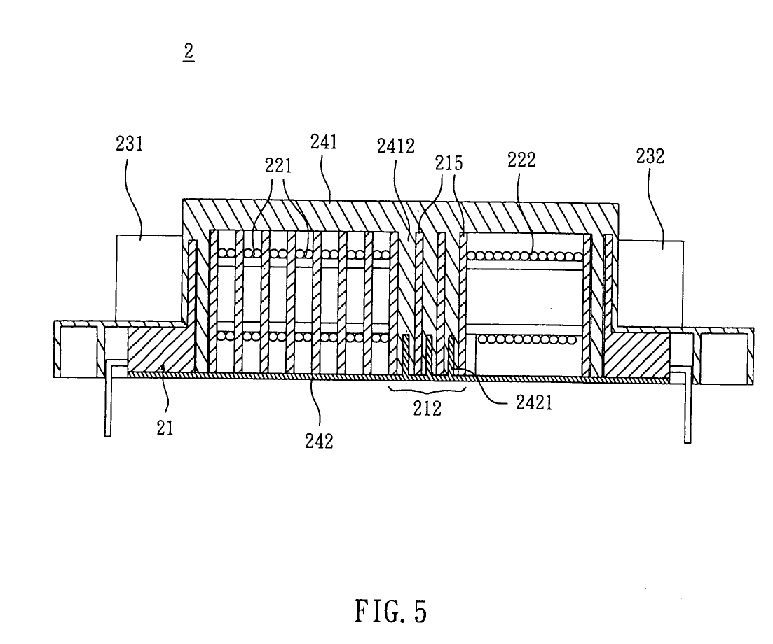

The assembling method of the transformer 2 will be described hereinafter. Herein, the first casing 241 has a through hole 2411, and the bobbin 21 has a through hole 214. When the first casing 241 covers the bobbin 21, the first insulating protrusions 2412 of the first casing 241 are disposed in the insulating slots 216 located in the non-winding area 212. The first insulating protrusions 2412 and the partitions 215 of the bobbin 21 are alternately arranged, thereby forming a portion of the insulating structure between the first winding 221 and the second winding 222. Then, the centers of the cores 231 and 232 are oppositely passing through the through holes 2411 and 214, respectively, and abut against each other. The first winding 221 and the second winding 222 are wound around the cores 231 and 232 so as to form a closed magnetic loop. Therefore, the core set 23 can couple with the first winding 221 and the second winding 222. Finally, the second casing 242 is connected with the first casing 241. The second insulating protrusions 2421 of the second casing 242 are disposed in the insulating slots 216 located in the non-winging area 212. Therefore, the second insulating protrusions 2421 and the partitions 215 of the bobbin 21 can be alternately arranged. Preferably, the second insulating protrusions 2421 may be further connected with the first insulating protrusions 2412 of the first casing 241 so as to form a closed path (as shown in FIG. 5). Accordingly, the first insulating protrusions 2412 of the first casing 241, the second insulating protrusions 2421 of the second casing 242 and the partitions 215 of the bobbin 21 can together form the insulating structure.

FIG. 5 is a cross-sectional view of the transformer along line AA′ shown in FIG. 4. As shown in FIG. 5, the first insulating protrusions 2412 and the second insulating protrusions 2421 are alternately arranged with the partitions 215 when the first casing 241 and the second casing 242 cover the bobbin 21, the first winding 221 and the second winding 222. Thus, it is possible to provide a large traveling distance in a small space. Furthermore, the first insulating protrusions 2412 and the second insulating protrusions 2421 are connected to form a closed path so that the transformer 2 can attain better insulation effect.

In summary, the transformer of the invention is consisted of the cover and the bobbin. The insulating protrusions of the cover and the insulating slots of the bobbin are correspondingly disposed so that the insulating protrusions and the insulating partitions are alternately arranged. Therefore, an insulating structure can be formed between the primary and secondary windings, and the bobbin, first winding and second winding can be covered in a closed path formed by the cover so as to attain the insulation effect. Compared with the prior art, the transformer of the invention has the insulating structure capable of insulating the primary and secondary windings efficiently. Thus, the transformer of the invention can fit the clearance and creepage distances requirements in the safety regulations.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A transformer comprising:
a bobbin having a first winding area, a second winding area and a non-winding area disposed between the first and second winding areas;
a first winding wound around the bobbin;
a second winding wound around the bobbin;
a core set coupled to the bobbin; and
a cover covering the bobbin, the first winding and the second winding, wherein the non-winding area has a plurality of partitions so that an insulating slot is formed between two adjacent partitions.

2. The transformer according to claim 1, wherein the first winding is a primary winding and the second winding is a secondary winding.

3. The transformer according to claim 1, wherein the cover is made of a non-magnetic material or plastic.

4. The transformer according to claim 1, wherein an inner wall of the cover facing the bobbin is formed with a plurality of insulating protrusions correspondingly disposed in the insulating slots.

5. The transformer according to claim 4, wherein the cover comprises a first casing and a second casing.

6. The transformer according to claim 5, wherein the insulating protrusions are disposed on inner walls of the first and second casings.

7. The transformer according to claim 6, wherein the insulating protrusions disposed on the inner wall of the first casing are correspondingly connected with the insulating protrusions disposed on the inner wall of the second casing.

8. The transformer according to claim 6, wherein the insulating protrusions and the partitions of the bobbin are alternately arranged.

9. The transformer according to claim 1, wherein the core set has two cores.

10. The transformer according to claim 9, wherein the core set is an EE-type core set, an EF-type core set, an EI-type core set, an EC-type core set, an EER-type core set, an ETD-type core set, an UI-type core set, an EPC-type core set or an EFD-type core set.

11. The transformer according to claim 10, wherein the bobbin and the cover both have a through hole for allowing the core set to pass therethrough.

12. A transformer comprising:
a bobbin having a plurality of partitions, wherein an insulating slot is formed between the two adjacent partitions;
a first winding wound around the bobbin;
a second winding wound around the bobbin, wherein the partitions are disposed between the first winding and the second winding;
a core set coupled to the bobbin;
a first casing covering a portion of the bobbin and having at least one first insulating protrusion extending to the insulating slot; and
a second casing covering a residual portion of the bobbin and having at least one second insulating protrusion extending to the insulating slot.

13. The transformer according to claim 12, wherein the first winding is a primary winding and the second winding is a secondary winding.

14. The transformer according to claim 12, wherein the cover is made of a non-magnetic material or plastic.

15. The transformer according to claim 12, wherein the first insulating protrusion is connected with the second insulating protrusion.

16. The transformer according to claim 15, wherein the first insulating protrusion and the second insulating protrusion are alternately arranged with the partitions of the bobbin.

17. The transformer according to claim 12, wherein the bobbin, the first casing and the second casing both have a through hole for passing the core set therethrough.

18. The transformer according to claim 12, wherein the core set has two cores.

19. The transformer according to claim 18, wherein the core set is an EE-type core set, an EF-type core set, an EI-type core set, an EC-type core set, an EER-type core set, an ETD-type core set, an UI-type core set, an EPC-type core set or an EFD-type core set.
